(19) United States
(12) Patent Application Publication
(10) Pub. No.: US 2011/0285987 A1
(43) Pub. Date: Nov. 24, 2011

(54) Installation for the quality control of a surface of an object

(75) Inventor: Yves SURREL, Saint Etienne (FR)

(73) Assignee: VISUOL TECHNOLOGIES, Saint Julien Les Metz (FR)

(21) Appl. No.: 13/105,289

(22) Filed: May 11, 2011

(30) Foreign Application Priority Data
May 11, 2010 (FR) 10/02006

(51) Int. Cl. G01N 21/00

(52) U.S. Cl. 356/237.2

(57) ABSTRACT

This installation includes a support for the object, a panel having a fringe pattern alternating pale and dark lines, the pattern having a first series of parallel fringes extending in a first direction and at a first pitch, and a second series of parallel fringes extending in a second direction perpendicular to the first direction and at a second pitch, illuminating means arranged to illuminate the fringe pattern, at least one imaging capturing means to capture an image of the pattern reflected or transmitted by the surface of the object, and where at least one of the support, the panel and the capturing means is mobile between a plurality of positions, the movement between two successive positions of each chosen element being designed so as to produce a predetermined phase shift between two images of the pattern reflected or transmitted by said surface.

### TECHNICAL FIELD

The present invention relates to an installation for controlling the surface quality of an object.

### BACKGROUND

The quality of a surface can be inspected using phase shift deflectometry.

Phase shift deflectometry is a technique consisting of determining the geometry of a reflective or transparent surface of an object by means of the shape of its local slopes and curves, based on the distortion of the image of a moiré pattern in particular of grating type, reflected or transmitted by the surface of the object. By <<moiré>> is meant a pattern of fringes alternating pale and dark lines, generally with a sinusoidal or binary profile and sharp luminosity transition.

The distortion of the image of the moiré is captured by at least one image capturing means, in particular of camera type, each capturing means having a field of view. The, or each, capturing means is arranged to so that in the corresponding field of view it captures an image of the pattern of fringes that is reflected or transmitted by the surface of the object. The image of the fringe pattern reflected or transmitted by the surface of the object contains a periodic signal formed by the luminance of the fringe pattern reflected or transmitted by the surface of the object.

The periodic signal is sampled over at least one period with a minimum of three samples for each phase measurement. The phase map of the image of the fringe pattern is then conventionally extracted from the samples of the periodic signal using Fourier's fundamental component extraction method.

To obtain complete measurement of the slopes of the surface of the object to be inspected, two orthogonal directions of the fringes are needed. The slopes effectively have two components: if the geometry of the surface to be inspected is described within a Cartesian coordinate system (x, y, z) by the function z(x, y), the two components of the local slopes are ∂z/∂x and ∂z/∂y.

Two techniques used in deflectometry are known in the state of the art:
temporal phase-shifting,
spatial phase-shifting.

Temporal phase-shifting conventionally requires the use of a computerized display of a moiré pattern by a monitor (of LCD or plasma type), or of a video projector which projects onto a diffusion screen (by reflection or transmission).

The moiré pattern is moved via computerized processing so as to produce a predetermined phase shift between two images of the fringe pattern reflected or transmitted by the surface of the object. The main drawback with temporal phase-shifting is the limitation of monitor size, which does not allow slope measurements over a large-size surface area to be inspected. By <<large size>> is meant a surface having a surface area of more than 0.5 m².

In addition, the use of a video projector is not suitable for industrial environments on account of the fragility thereof, its high cost and the highly limited lifetime of the light bulbs used. Also, the use of a video projector makes the installation bulky since a space must be provided separating the video projector from the diffusing screen.

Spatial phase-shifting uses a fixed moiré. Measurement of the phase of the image of the fringe pattern, reflected or transmitted by the surface of the object, is conducted in the vicinity of a point on the surface of the object, from the captured image of a pixel by a camera directed on this point and a group of neighbouring pixels. Therefore one first disadvantage of spatial phase-shifting is the limited spatial resolution of phase measurement since several neighbouring pixels are required to perform a local measurement.

Additionally, a second drawback of spatial phase-shifting is the constraint that the image of the fringe pattern reflected or transmitted by the surface of the object must not be too deformed, so that the apparent variation in the spatial frequency of the said image is sufficiently small to extract the phase. Therefore only near-planar, near-spherical, near-cylindrical or near-toric objects are able to benefit from surface quality control using spatial phase-shifting.

### BRIEF SUMMARY

The present invention sets out to remedy all or part of the afore-mentioned disadvantages, and concerns an installation for the quality control of a surface of an object, noteworthy in that it comprises:
a support for the object,
a panel comprising a fringe pattern alternating pale and dark lines, the fringe pattern having a first series of substantially parallel fringes extending in a first direction and at a first pitch, and a second series of substantially parallel fringes extending in a second direction substantially perpendicular to the first direction and at a second pitch,
illuminating means arranged to illuminate the fringe pattern,
at least one image capturing means, in particular of camera type, the or each capturing means having a field of view, and being arranged so that in the corresponding field of view it captures an image of the fringe pattern reflected or transmitted by the surface of the object, and
at least one element, chosen from the group comprising the support for the object, the panel and the or each capturing means, is mobile between a plurality of positions, the movement between two successive positions of each chosen element being designed so as to produce a predetermined phase shift between two images of the fringe pattern reflected or transmitted by the surface of the object.

Therefore the presence of a panel forming a moiré pattern allows the obtaining of a large-sized moiré to be envisaged which is easy to use and low-cost, in particular by printing crossed dark lines on a light-coloured panel, and thereby permits the quality control of a large size surface such as a surface of a motor vehicle, unlike the case with temporal phase-shifting. In addition, said panel is robust and durable, which is favourable for industrial environments.

Also, said fringe pattern allows complete measurement of the slopes of the surface of the object to be inspected.

Said mobility of the element chosen from the group comprising the support for the object, the panel and the capturing means allows phase shifting to be produced, and allows the quality control of a surface of an object that is not necessarily near-planar, near-spherical, near-cylindrical or near-toric, which cannot be envisaged with spatial phase-shifting.

In one embodiment, the panel is mobile in the first and in the second direction of the fringe pattern, respectively between a first and a second plurality of positions, the movement between two successive positions of the first and second plurality of positions respectively corresponding to a predetermined whole fraction of the first and second pitch of the fringe pattern.

Therefore, said mobility of the panel allows a predetermined phase shift to be produced between two images of the fringe pattern reflected or transmitted by the surface of the object.

Advantageously, the or each image capturing means is arranged to capture the image of the fringe pattern reflected or transmitted by the surface of the object in each of the first and second plurality of positions of the panel.

Therefore said arrangement of the, or of each, capturing means allows the spatial resolution of phase measurement to be optimized. It is the same pixel which will capture the periodic signal generated by movement of the panel. This same pixel allows measurement of the phase exactly corresponding to the point of the object seen by this pixel. Said arrangement of the, or of each, capturing means makes it possible to avoid the need for phase measurement dependent upon a group of neighbouring pixels.

According to one embodiment, the installation comprises means for moving the panel comprising at least one first actuator and at least one second actuator, preferably of electric linear or pneumatic linear type, the first and second actuator being arranged to move the panel in the first and second direction respectively of the fringe pattern.

Therefore said moving means ensure the kinematics of the panel in the first and second direction of the fringe pattern.

Advantageously, the installation comprises guiding means, preferably guiding rails arranged to guide the panel in the first and second direction of the fringe pattern.

Therefore with said guiding means it is possible to improve the precision of the panel's kinematics.

According to one particular embodiment the panel has:
one so-called front face intended to be oriented towards the object, and comprising the fringe pattern,
an opposite so-called rear face,
through orifices arranged within the panel,

and the, or each capturing means is secured to the rear face of the panel so that, in the corresponding field of view via the through orifices, it is able to capture an image of the fringe pattern reflected or transmitted by the surface of the object.

According to one embodiment, the installation comprises capturing means and the object support is mobile around the point of the surface of the object located in the centre of the field of view of the capturing means, when the object is arranged on the support, the movement between two successive positions of the support being designed so as to produce a predetermined phase shift between two images of the fringe pattern reflected by the surface of the object.

Therefore said mobility of the support is an alternative to the mobility of the panel for producing a predetermined phase shift between two images of the fringe pattern reflected by the surface of the object.

According to one embodiment, the, or each capturing means is mobile around the centre of the corresponding field of view between the plurality of positions, the centre of the corresponding field of view being intended to focus on a fixed point of the surface of the object.

Therefore said mobility of the, or of each capturing means is an alternative to the mobility of the panel and to the mobility of the support for producing a predetermined phase shift between two images of the fringe pattern reflected or transmitted by the surface of the object. In addition, said mobility of the, or of each capturing means is particularly adapted for <<transmission mode>> i.e. for producing a predetermined phase shift between two images of the fringe pattern transmitted by the surface of the object.

According to one variant of embodiment the, or each capturing means is mobile in translation relative to the surface of the object between the plurality of positions, and the installation comprises means for processing the captured images, the processing means being configured to perform registration of said captured images by translation on a fixed point of the surface of the object.

This variant is therefore of particular advantage when each capturing means is mobile in rotation around the centre of the corresponding field of view focusing on a fixed point of the surface of the object, this fixed point possibly being distant from the capturing means e.g. by 1.5 to 2 m. The movement of the capturing means, which is coupling between a translation and a rotation through a very small angle (of the order of one degree to a few degrees) can prove to be difficult to implement to ensure that the image captured in the field of view does not move to within one pixel.

Depending on the variant of embodiment the, or each capturing means is merely translated which simplifies the mechanical movement, and the focusing on the reference which is the fixed point of the surface of the object is ensured by image registration by translation of the captured images via processing means.

According to one advantageous characteristic, the first pitch of the fringe pattern is substantially equal to the second pitch.

Therefore, the sampling of the periodic signals formed by the luminosity of the fringe pattern reflected or transmitted by the surface of the object, and the phase extraction of the samples are simplified and require a shorter computing time.

Advantageously the panel is made in a flexible material and extends so as to form a portion of a cylinder.

With said shape of the panel, it is possible to increase significantly the apparent size of the panel image on an object of convex shape, the object being intended to be located inside the cylinder portion.

### BRIEF DESCRIPTION OF THE DRAWINGS

Other characteristics and advantages will become apparent in the following description of three embodiments of an installation for the quality control of a surface of an object according to the invention, given as non-limiting examples, with reference to the appended drawings in which:

FIG. 1 is a partial view of an installation according to a first embodiment,

FIG. 2 is a schematic view of an array of movements of the panel illustrated FIG. 1,

FIG. 3 is a partial schematic view of an installation according to a second embodiment,

FIG. 4 is a partial, schematic view of an installation according to a third embodiment,

FIG. 5 is a similar view to FIG. 3 illustrating a variant of implementation of the second embodiment.

### DETAILED DESCRIPTION

For the different variants of embodiment, the same references may be used for identical elements or for elements ensuring the same function, for reasons of simplification of the description.

The installation for controlling the quality of a surface of an object illustrated in FIG. 1 comprises:
a support 1 for the object such as a floor,
a panel 2,
illuminating means (not shown) such as fluorescent tubes or light emitting diodes,
image capturing means comprising cameras (not illustrated),

The panel 2 comprises:
a so-called front face 20 intended to be oriented towards the object,
an opposite, so-called rear face 21,
through orifices (not illustrated) arranged within the panel.

The front face 20 of the panel 2 comprises a fringe pattern 3 alternating pale 30 and dark 31 lines, the fringe pattern 3 having a first series of substantially parallel fringes extending in a first curvilinear direction and at a pitch p, and a second series of substantially parallel fringes extending in a second direction substantially perpendicular to the first curvilinear direction and at a pitch p.

According to one form of embodiment, the panel 2 is made in an opaque material and the illuminating means are arranged to illuminate the front face of the panel 2.

According to one variant of embodiment, the panel 2 is made in a translucent material and the illuminating means are arranged to illuminate the rear face of the panel 2.

The cameras are fixed to the rear face 21 of the panel 2. Each camera has a field of view and is arranged so that, in its field of view via the through orifices, it is able to capture an image of the fringe pattern 3 reflected or transmitted by the surface of the object. Advantageously the cameras can be synchronized with each other.

The panel 2 is made in a flexible material and extends substantially so as to form a portion of a cylinder whose generatrix extends substantially parallel to the second direction of the fringe pattern 3. The object is intended to be arranged inside the portion of cylinder.

The panel 2 is mobile between a plurality of positions, the movement between two successive positions being designed so as to produce a predetermined phase shift between two images of the fringe pattern 3 reflected or transmitted by the surface of the object.

To do so, the panel 2 is mobile in the first and the second direction of the fringe pattern 3 respectively between a first and a second plurality of positions, the movement between two successive positions of the first and second plurality of positions corresponding to a predetermined whole fraction of the pitch p of the fringe pattern 3.

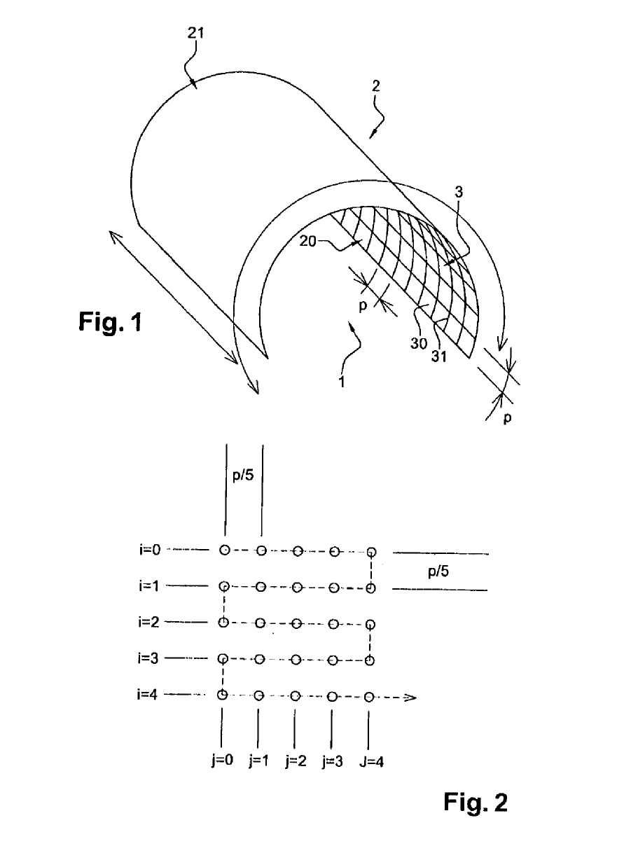

In the example illustrated in FIG. 2, the panel 2 is mobile in the first and in the second direction of the fringe pattern 3, respectively between a first plurality of five positions (denoted j and numbered from 0 to 4), and a second plurality of five positions (denoted i and numbered from 0 to 4), the movement between two successive positions of the first and of the second plurality of positions corresponding to one fifth of the pitch p of the fringe pattern 3.

The cameras are arranged to capture the image of the fringe pattern 3 reflected or transmitted by the surface of the object in each of the first and of the second plurality of positions of the panel 2

The installation comprises means for moving the panel 2 (not illustrated) comprising:
at least one first actuator, possibly being of electric linear or pneumatic linear type, arranged to move the panel 2 in the first direction of the fringe pattern 3,
at least one second actuator, possibly being of electric linear or pneumatic linear type arranged to move the panel 2 in the second direction of the fringe pattern 3.

The installation comprises:
two circular guide rails (not illustrated) arranged either side of the panel 2 and arranged to guide the panel 2 in the first direction of the fringe pattern 3,
two longitudinal guide rails (not illustrated) arranged either side of the panel 2 and arranged to guide the panel 2 in the second direction of the fringe pattern 3.

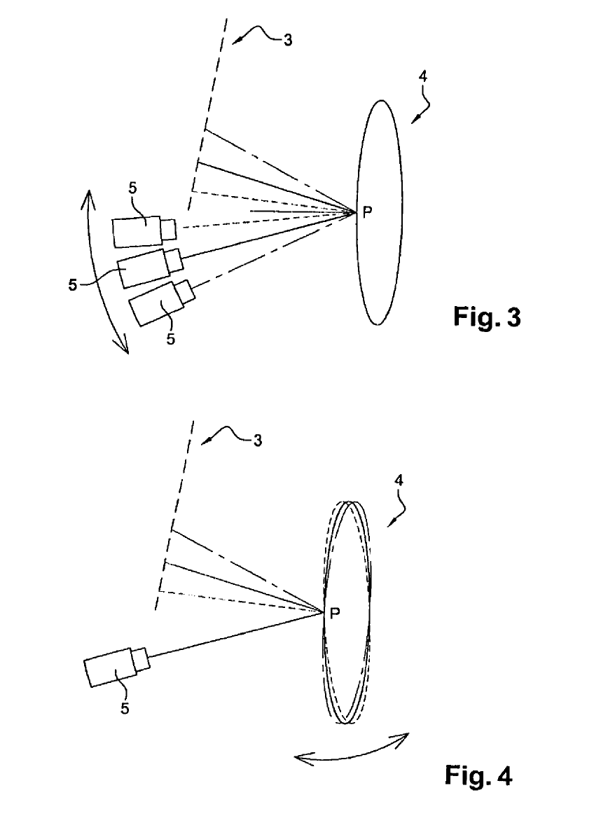

According to the embodiment illustrated in FIG. 3, the installation differs from the installation shown in FIG. 1 in that:
the panel is fixed,
the installation comprises at least one camera 5 (only one is shown),
each camera 5 is mobile in rotation around the centre of its field of view, the centre of the field of view focusing on a fixed point P of the surface of the object 4.

According to the variant of embodiment illustrated in FIG. 5, the installation differs from the installation illustrated in FIG. 3 in that:
each camera 5 (only one is shown) is mobile in translation relative to the surface of the object 4 between a plurality of positions, the centre of the field of view respectively focusing on the points P′, P and P″ in the plurality of positions,
the installation comprises processing means (not illustrated) of the captured images, the processing means being configured to perform registration of said captured images by translation on the fixed point P of the surface of the object 4.

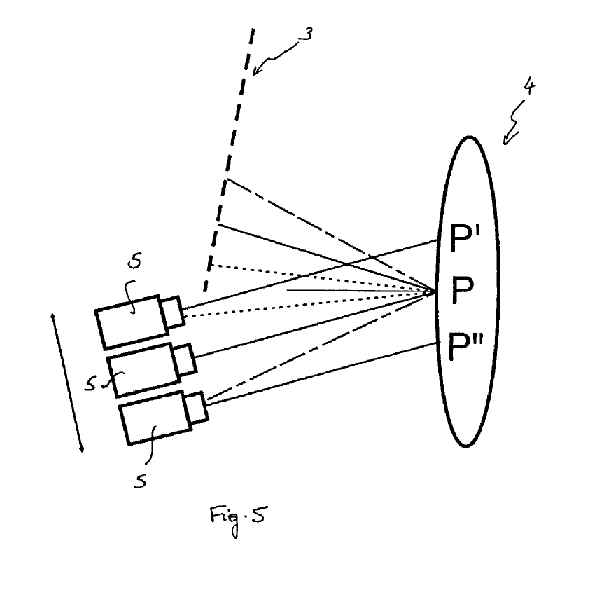

According to the embodiment illustrated in FIG. 4, the installation differs from the installation illustrated in FIG. 1 in that:
the panel 2 is fixed,
the installation comprises a camera 5,
the support 1 for the object 4 is mobile around point P of the surface of the object 4 positioned in the centre of the field of vision of the camera 5, the movement between two successive positions of the support 1 being designed so as to produce a predetermined phase shift between two images of the fringe pattern 3 reflected by the surface of the object 4.

Said mobility of the support 1 for the object 4 comprises rotations around this point P in order to move an image of the fringe pattern 3 reflected by the surface of the object 4 without moving the object itself 4 into the field of view. The rotations are performed about axes determined so that the images of the fringe pattern 3 reflected by the surface of the object 4 are moved in directions corresponding to their phase shift.

The embodiments of the invention described in the foregoing evidently have no limiting nature. Details and improvements can be made thereto in other variants of embodiment without, however, departing from the scope of the invention.

1. An installation for quality control of a surface of an object comprising:
a support for the object,
a panel comprising a fringe pattern alternating pale and dark lines, the fringe pattern having a first series of substantially parallel fringes extending in a first direction and at a first pitch, and a second series of substantially parallel fringes extending in a second direction substantially perpendicular to the first direction and at a second pitch,
illuminating means arranged to illuminate the fringe pattern,
at least one image capturing means comprising a camera, the capturing means having a field of view and being arranged so that, in the corresponding field of view, it is able to capture an image of the fringe pattern reflected or transmitted by a surface of the object, and
wherein at least one of the support for the object, the panel and the or each capturing means, is mobile between a plurality of positions, movement between two successive positions of each chosen element being designed so as to produce a predetermined phase shift between two images of the fringe pattern reflected or transmitted by the surface of the object.

2. The installation according to claim 1, wherein the panel is mobile in the first and in the second direction of the fringe pattern respectively between a first and a second plurality of positions, the movement between two successive positions of the first and of the second plurality of positions respectively corresponding to a predetermined whole fraction of the first and of the second pitch of the fringe pattern.

3. The installation according to claim 2, wherein the image capturing means is arranged to capture the image of the fringe pattern reflected or transmitted by the surface of the object in each of the first and of the second plurality of positions of the panel.

4. The installation according to claim 2, further comprising means for moving the panel, comprising at least one first actuator and at least one second actuator, of electric linear or pneumatic linear type, the first and the second actuator being arranged to move the panel in the first and the second direction respectively of the fringe pattern.

5. The installation according to claim 4, further comprising guiding means arranged to guide the panel in the first and the second direction of the fringe pattern.

6. The installation according to claim 2, wherein the panel has:
one front face intended to be oriented towards the object, and comprising the fringe pattern,
an opposite rear face,
through orifices arranged within the panel,
and wherein the capturing means is attached to the rear face of the panel so that, in the corresponding field of view and via the through orifices, it is able to capture an image of the fringe pattern reflected or transmitted by the surface of the object.

7. The installation according to claim 1, further comprising capturing means, and wherein the support for the object is mobile around a point of the surface of the object located in a center of the field of view of the capturing means, when the object is arranged on the support, the movement between two successive positions of the support being designed so as to produce a predetermined phase shift between two images of the fringe pattern reflected by the surface of the object.

8. The installation according to claim 1 wherein the capturing means is mobile around a center of the corresponding field of view between the plurality of positions, the center of the corresponding field of view being intended to focus on a fixed point of the surface of the object.

9. The installation according to claim 1 wherein the capturing means is mobile in translation relative to the surface of the object between the plurality of positions, and wherein the installation comprises means for processing the captured images, the processing means being configured to perform registration of said captured images by translation on a fixed point of a surface of the object.

10. The installation according to claim 1, wherein the first pitch of the fringe pattern is substantially equal to the second pitch.

11. The installation according to claim 1, wherein the panel is made in a flexible material and extends so as to form a portion of a cylinder.
